(19) United States
(12) Patent Application Publication
(10) Pub. No.: US 2023/0036074 A1
(43) Pub. Date: Feb. 2, 2023

(54) ENERGY STORAGE DEVICE

(71) Applicant: GUANGDONG MIC-POWER NEW ENERGY CO., LTD., Huizhou (CN)

(72) Inventors: Zhiyong CHEN, Huizhou (CN); Weixin LIAO, Huizhou (CN)

(21) Appl. No.: 17/789,960

(22) PCT Filed: Jul. 17, 2020
(86) PCT No.: PCT/CN2020/102567

§ 371 Date: Jun. 29, 2022

(30) Foreign Application Priority Data
Dec. 30, 2019 (CN) 201922456310.5

(51) Int. Cl. H01M 50/588; H01M 50/296; H01M 50/522; H01M 50/524; H01M 50/526; H01M 50/593

(52) U.S. Cl. CPC H01M 50/588; H01M 50/296; H01M 50/522; H01M 50/524; H01M 50/526; H01M 50/593

(57) ABSTRACT

Disclosed is an energy storage device, including a device body, an electric connector and an insulating member. The device body has a positive electrode region and a negative electrode region which are insulated from each other, a part of the electric connector is connected with the positive electrode region or the negative electrode region and another part of the electric connector protrudes outward from the device body, and the insulating member is provided on the electric connector and/or the device body and configured to prevent the device from shorting. (FIG. 1)

### TECHNICAL FIELD

The present disclosure relates to the technical field of electrical energy storage, and particularly to an energy storage device.

### BACKGROUND

Batteries and capacitors have been widely used in various miniature electronic products. As traditional batteries or capacitors supply power to electronic modules through special connectors, there are inconveniences in adjusting positions of electronic modules in electronic products.

Therefore, there is a need to provide a new technical solution to solve at least one of the above technical problems.

### SUMMARY

An object of the present disclosure is to provide an energy storage device.

A energy storage device includes a device body, an electric connector and an insulating member, device body has a positive electrode region and a negative electrode region which are insulated from each other, a part of the electric connector is connected with the positive electrode region or the negative electrode region and another part of the electric connector protrudes outward from the device body, and the insulating member is provided on the electric connector and/or the device body and configured to prevent the device from shorting.

Optionally, the electric connector includes: a positive electrode connector connected to the positive electrode region; and a negative electrode connector connected to the negative electrode region; at least one of the positive electrode connector and the negative electrode connector is provided with the insulating member.

Optionally, the positive electrode region and the negative electrode region are disposed opposite to each other; or

Optionally, the device body includes a top, a bottom, and a side wall between the top and bottom, the positive electrode region is located at the top or the bottom, and the negative electrode region is located at the side wall, or the negative electrode region is located at the top or the bottom, and the positive electrode region is located at the side wall, or both the negative electrode region and the positive electrode region are located at the top or the bottom, or both the negative electrode region and the positive electrode region are located at the top or the side wall.

Optionally, the positive electrode connector and the negative electrode connector are equal in height.

Optionally, the electric connector is in the shape of a sheet or a strip, and the insulating member is sleeved on an end of the electric connector.

Optionally, the electric connector is L-shaped as a whole, and the L-shaped structure includes two sides connected together, one of which is fixedly connected to the device body, and the other of which protrudes outward from the device body.

Optionally, one end of the positive electrode connector and one end of the negative electrode connector are welded to the device body, and a protruding direction of the positive electrode connector is intersected with or parallel to that of the negative electrode connector.

Optionally, at least one of the positive electrode connector and the negative electrode connector includes a metal connector and a lead-out section, the metal connector includes a welding portion and a guide portion, the welding portion is welded on the device body, one end of the lead-out section is welded on the guide portion, and the guide portion is configured to guide a lead-out direction of the lead-out section.

Optionally, the metal connector further includes a positioning structure.

Optionally, the insulating member is an adhesive tape, a plastic tube or a rubber tube.

Optionally, the insulating member includes a first insulating member and a second insulating member, the first insulating member is provided between the device body and the other part of the electric connector, and the second insulating member is provided outside the one part of the electric connector.

With the energy storage device provided by the present disclosure, during operation, an electronic module is connected to the protruding portion of the electric connector, and the insulating portion insulates the electric connector from the device body. Since the electric connector has the protruding portion, it is possible to flexibly adjust the positions of the electronic module and the energy storage device. With the energy storage device of the present embodiment, it is possible to supply power to the electronic module through the protruding portion of the electric connector while eliminating shorting, without connecting through a dedicated battery holder. In this way, it is possible to achieve easy connection and easy adjustment, and ultimately to widen the functionality of electronic products.

Other features and advantages of the present disclosure will become apparent from the following detailed description of exemplary embodiments of the present disclosure with reference to the accompanying drawings.

### BRIEF DESCRIPTION OF THE DRAWINGS

The accompanying drawings, which constitute a part of the description, illustrate embodiments of the present disclosure and, together with the description thereof, serve to explain the principles of the present disclosure.

FIG. 1 is a schematic front view of the structure of an energy storage device in an embodiment of the present disclosure.

FIG. 2 is a schematic top view of the structure of the embodiment of FIG. 1.

FIG. 3 is a schematic view of the state after covering the positive electrode region shown in FIG. 2 with an insulating layer.

FIG. 4 is a schematic diagram of the three-dimensional structure of an energy storage device in an embodiment of the present disclosure.

FIG. 5 is a schematic diagram of the three-dimensional structure of the insulating layer in the embodiment of FIG. 4.

FIG. 6 is a schematic structural diagram after adjusting extension directions of the positive electrode connector and the negative electrode connector in the embodiment of FIG. 4.

FIG. 7 is a schematic diagram of the three-dimensional structure of an energy storage device in an embodiment of the present disclosure.

FIG. 8 is a schematic side view of the structure of the embodiment of FIG. 7.

FIG. 9 is a schematic structural diagram after adjusting the distance between the positive electrode connector and the negative electrode connector in the embodiment of FIG. 7.

FIG. 10 is a schematic structural diagram after adjusting extension directions of the positive electrode connector and the negative electrode connector in the embodiment of FIG. 7.

### DESCRIPTION OF REFERENCE SIGNS

1-device body, 11-positive electrode region, 12-negative electrode region;

2-electric connector, 21-positive electrode connector, 22-negative electrode connector, 23-welding portion, 24-guide portion;

3-insulating member, 31-insulating sleeve, 32-insulating layer.

### DETAILED DESCRIPTION

Various exemplary embodiments of the present disclosure will now be described in detail with reference to the accompanying drawings. It should be noted that the relative arrangement, numerical expressions and numerical values of the components and steps set forth in these examples do not limit the scope of the disclosure unless otherwise specified.

The following description of at least one exemplary embodiment is in fact merely illustrative and is in no way intended as a limitation to the present disclosure and its application or use.

Techniques, methods, and apparatus known to those of ordinary skill in the relevant art may not be discussed in detail but where appropriate, the techniques, methods, and apparatus should be considered as part of the description.

Among all the examples shown and discussed herein, any specific value should be construed as merely illustrative and not as a limitation. Thus, other examples of exemplary embodiments may have different values.

It should be noted that similar reference numerals and letters denote similar items in the accompanying drawings, and therefore, once an item is defined in a drawing, and there is no need for further discussion in the subsequent accompanying drawings.

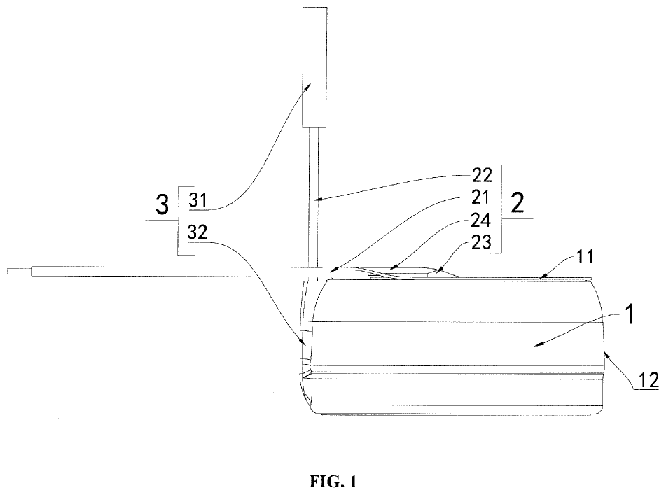

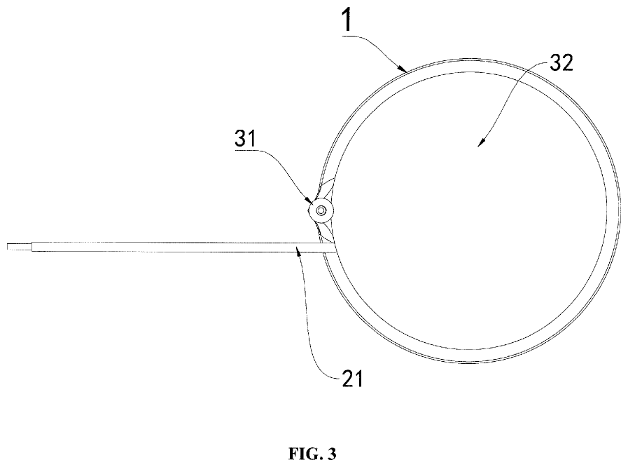

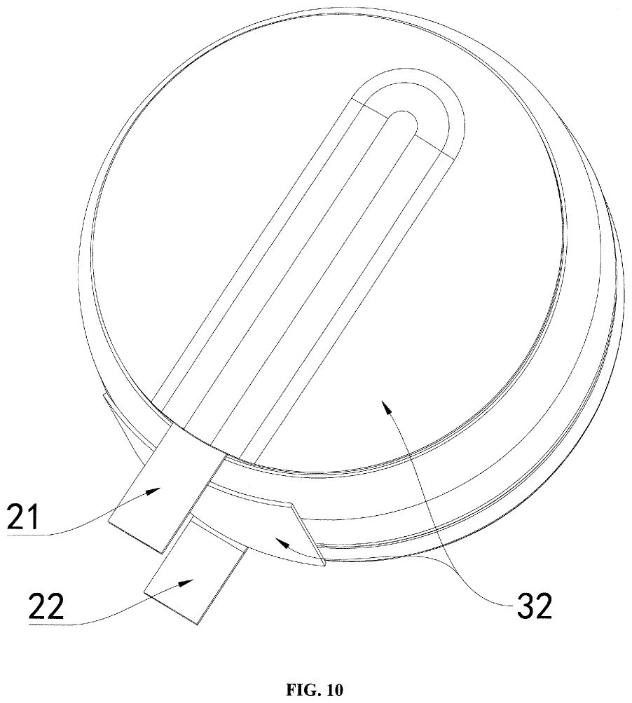

As shown in FIGS. 1 to 10, an energy storage device includes a device body 1, an electrical connector 2, and an insulating member 3. The device body 1 is a battery or a capacitor, wherein the battery includes any one of a columnar battery, a button battery, a square battery, and a heteromorphic battery.

The device body 1 has a positive electrode region 11 and a negative electrode region 12 which are insulated from each other. A part of the electric connector 2 is connected to the positive electrode region 11 or the negative electrode region 12, and another part of the electric connector 2 protrudes outward from the device body 1 and can adjust its protruding direction according to actual needs.

The insulating member 3 is provided on the electric connector and/or the device body 1, and is configured to prevent the device from shorting. The insulating member 3 includes an insulating sleeve 31 and an insulating layer 32, the insulating sleeve 31 is a plastic tube or a rubber tube, and the insulating layer 32 includes any one of a rubber insulating layer, a resin insulating layer, and an insulating tape.

During operation, an electronic module is connected to the protruding portion of the electric connector, and the insulating portion insulates the electric connector from the device body. Since the electric connector has the protruding portion, it is possible to flexibly adjust the positions of the electronic module and the energy storage device. With the energy storage device of the present embodiment, it is possible to supply power to the electronic module through the protruding portion of the electric connector while eliminating shorting, without connecting through a dedicated battery holder. In this way, it is possible to achieve easy connection and easy adjustment, and ultimately to widen the functionality of electronic products.

As shown in FIG. 1, in one embodiment, the electric connector 2 includes a positive electrode connector 21 connected to the positive electrode region 11 and a negative electrode connector 22 connected to the negative electrode region 12. At least one of the positive electrode connector 21 and the negative electrode connector 22 is provided with an insulating member.

As shown in FIG. 1, one end of the positive electrode connector 21 is provided with an insulating sleeve 31, and the other end is provided with an insulating layer 32. The insulating sleeve 31 is used to prevent the positive electrode connector 21 and the negative electrode connector 22 from shorting.

One part of the positive electrode connector 21 and one part of the negative electrode connector 22 can respectively protrude outward from the device body 1. During operation, the electronic module is connected with the protruding portions of the positive electrode connector 21 and the negative electrode connector 22 respectively, and the insulating member insulates the device body from the positive electrode connector 21. Alternatively, the insulating member insulates the device body from the negative electrode connector 22.

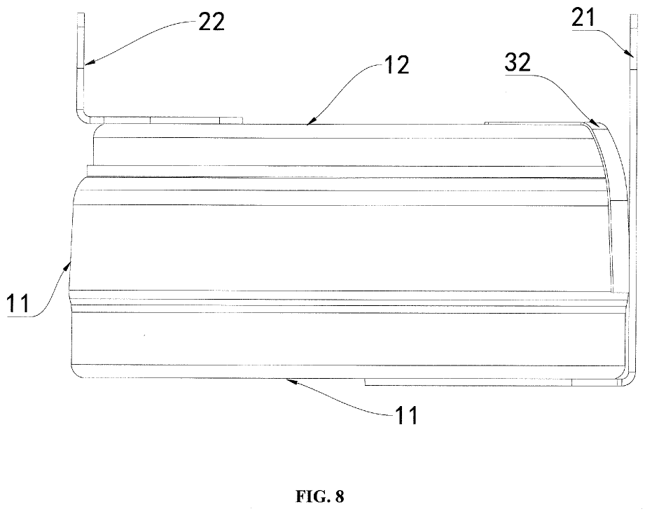

As shown in FIG. 8, in one embodiment, the positive electrode region 11 and the negative electrode region 12 are disposed opposite to each other.

In one embodiment, the device body 1 includes a top, a bottom, and a side wall located between the top and bottom. The positions of the positive electrode region 11 and the negative electrode region 12 can be adjusted according to actual needs.

As shown in FIG. 1, for example, the positive electrode region 11 is located at the top or the bottom, and the negative electrode region 12 is located at the side wall.

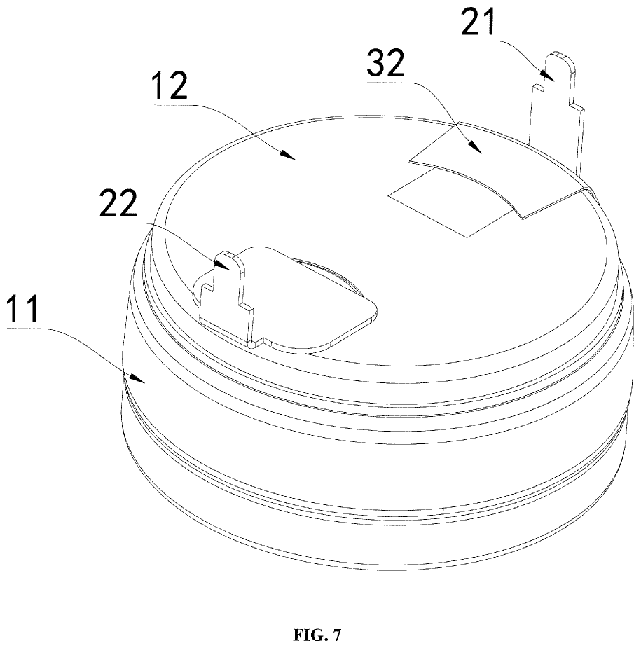

As shown in FIG. 7, for example, the negative electrode region 12 is located at the top or the bottom, and the positive electrode region 11 is located at the side wall.

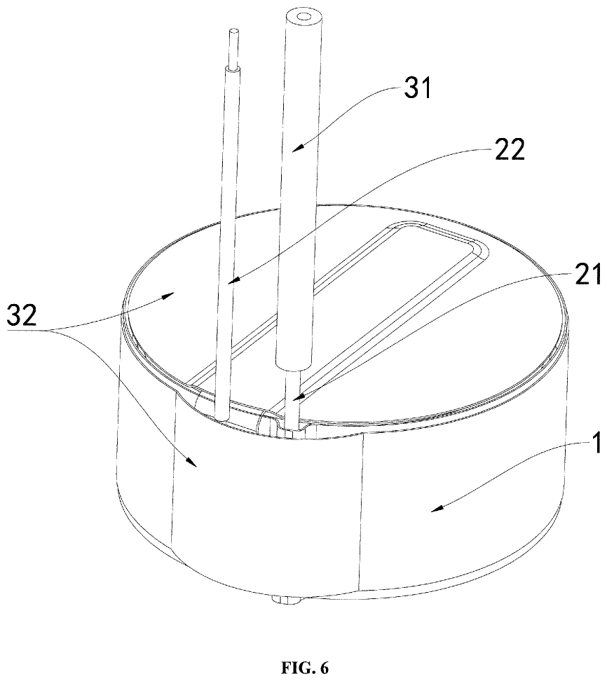

As shown in FIGS. 6-9, for example, both the negative electrode region 12 and the positive electrode region 11 are located at the top or the bottom.

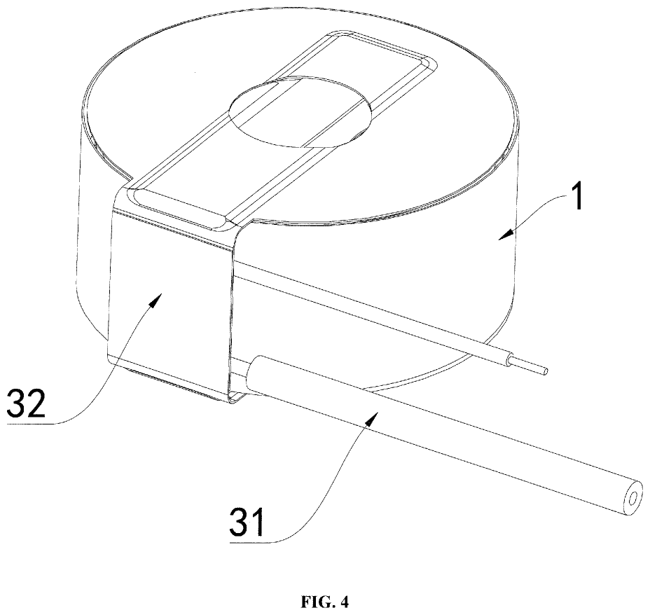

As shown in FIG. 4, for example, both the negative electrode region 12 and the positive electrode region 11 are located at the side wall.

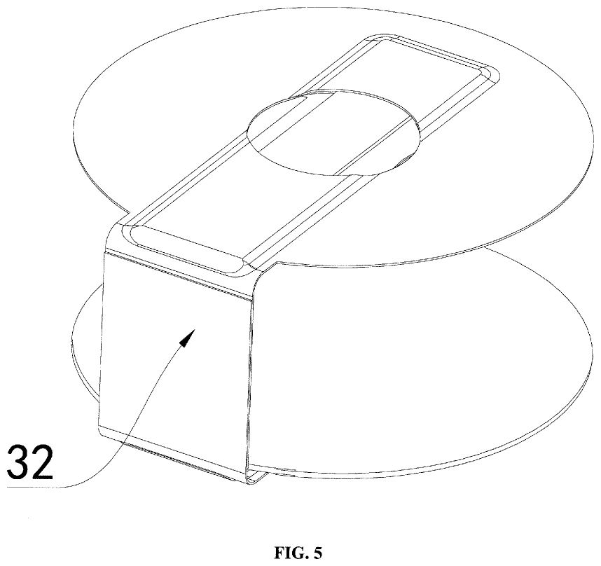

As shown in FIG. 5, in one embodiment, the insulating layer 32 includes an upper insulating layer, a lower insulating layer and a side insulating layer. Two ends of the side insulating layer are respectively connected to the upper insulating layer and the lower insulating layer, the upper insulating layer covering the positive electrode region 11, the lower insulating layer covering the negative electrode region 12, and the protruding portion of the electric connector protruding from the gap between the side insulating layer and the device body 1.

As shown in FIGS. 7 to 9, in one embodiment, the positive electrode connector 21 and the negative electrode connector 22 are equal in height. For example, a part of the negative electrode connector 22 is welded to the top of the device body 1, and a part of the positive electrode connector 21 is welded to the bottom of the device body 1; the protruding portion of the negative electrode connector 22 is equal in height to the protruding portion of the positive electrode connector 21, so as to facilitate connection with the electronic module.

As shown in FIGS. 7 to 10, in one embodiment, the electric connector is a metal sheet.

As shown in FIGS. 1 to 6, in one embodiment, the electric connector is a wire.

As shown in FIGS. 7 to 9, in one embodiment, the electric connector is L-shaped as a whole, and the L-shaped structure includes two sides connected together, one of which is fixedly connected to the device body, and the other of which protrudes outward from the device body.

As shown in FIGS. 1 and 6, in one embodiment, one end of the positive electrode connector 21 and one end of the negative electrode connector 22 are welded to the top and the side of the device body 1 respectively, and the protruding direction of the positive electrode connector 21 can intersect with or be parallel to that of the negative electrode connector 22. Intersection of the protruding directions enables the energy storage device of the present embodiment to connect the electronic modules in two directions, that is, the connection in the horizontal and vertical directions or the connection in the horizontal and vertical directions, and finally realize a convenient and flexible connection.

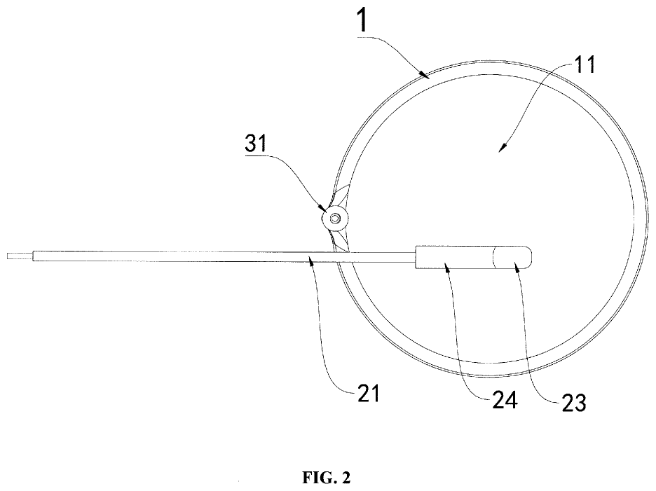

As shown in FIGS. 1 and 2, in one embodiment, at least one of the positive electrode connector 21 and the negative electrode connector 22 includes a metal connector and a lead-out section, wherein the lead-out section is a wire covered with an insulating layer.

The metal connector includes a welding portion 23 and a guide portion 24, wherein the welding portion 23 is welded on the device body 1, one end of the lead-out section is welded on the guide portion 24, and the guide portion 24 is configured to guide the lead-out direction of the lead-out section.

In one embodiment, the metal connector further includes a positioning structure, which is provided on the guide portion 24 and capable of holding the wire.

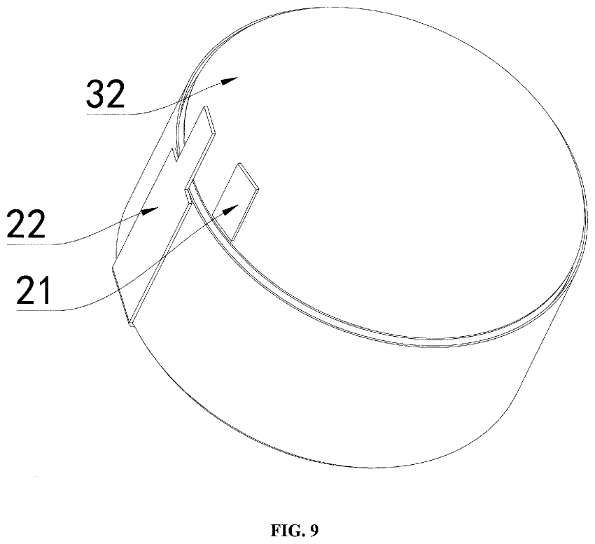

In one embodiment, the insulating member includes a first insulating member and a second insulating member, wherein the first insulating member is provided between the device body and the other part of the electric connector, and the second insulating member is provided outside the one part of the electric connector. For example, as shown in FIG. 8, the first insulating member is provided between the device body 1 and the positive electrode connector 21, and as shown in FIG. 9, the second insulating member covers the welded portion of the positive electrode connector 21. In the case of double insulation of the first insulating member and the second insulating member, it is possible to further insulate the positive electrode connector 21 from the negative electrode region 12; or to further insulate the negative electrode connector 22 from the positive electrode region 11.

While certain specific embodiments of the present disclosure have been illustrated by way of example, it will be understood by those skilled in the art that the foregoing examples are provided for the purpose of illustration and are not intended to limit the scope of the present disclosure. It will be understood by those skilled in the art that the foregoing embodiments may be modified without departing from the scope and spirit of the disclosure. The scope of the present disclosure is subject to the attached claims.

1. An energy storage device, comprising a device body, an electric connector and an insulating member,
the device body has a positive electrode region and a negative electrode region which are insulated from each other;
a first part of the electric connector is connected with the positive electrode region or the negative electrode region;
a second part of the electric connector protrudes outward from the device body; and
the insulating member is provided on the electric connector and/or the device body and configured to prevent the device from shorting.

2. The energy storage device of claim 1, wherein the electric connector comprises:
a positive electrode connector connected to the positive electrode region; and
a negative electrode connector connected to the negative electrode region;
at least one of the positive electrode connector and the negative electrode connector is provided with the insulating member.

3. The energy storage device of claim 2, wherein the positive electrode region and the negative electrode region are disposed opposite to each other; or
the device body comprises a top, a bottom, and a side wall between the top and bottom,
the positive electrode region is located at the top or the bottom, and the negative electrode region is located at the side wall, or
the negative electrode region is located at the top or the bottom, and the positive electrode region is located at the side wall, or
both the negative electrode region and the positive electrode region are located at the top or the bottom, or
both the negative electrode region and the positive electrode region are located at the side wall.

4. The energy storage device of claim 2, wherein the positive electrode connector and the negative electrode connector are equal in height.

5. The energy storage device of claim 1, wherein the electric connector is in the shape of a sheet or a strip, and the insulating member is sleeved on an end of the electric connector.

6. The energy storage device of claim 1, wherein the electric connector is of an L-shaped structure as a whole, and the L-shaped structure comprises two sides connected together, one of which is fixedly connected to the device body, and the other of which protrudes outward from the device body.

7. The energy storage device of claim 2, wherein one end of the positive electrode connector and one end of the negative electrode connector are welded to the device body, and a protruding direction of the positive electrode connector is intersected with or parallel to that of the negative electrode connector.

8. The energy storage device of claim 2, wherein at least one of the positive electrode connector and the negative electrode connector comprises a metal connector and a lead-out section, the metal connector comprises a welding portion and a guide portion, the welding portion is welded on the device body, one end of the lead-out section is welded on the guide portion, and the guide portion is configured to guide a lead-out direction of the lead-out section.

9. The energy storage device of claim 8, wherein the metal connector further comprises a positioning structure.

10. The energy storage device of claim 1, wherein the insulating member is an adhesive tape, a plastic tube or a rubber tube.

11. The energy storage device of claim 1, wherein the insulating member comprises a first insulating member and a second insulating member, the first insulating member is provided between the device body and the second part of the electric connector, and the second insulating member is provided outside the first part of the electric connector.
